(19) United States
(12) Patent Application Publication
(10) Pub. No.: US 2014/0004327 A1
(43) Pub. Date: Jan. 2, 2014

(54) FEW-LAYER GRAPHENE NANORIBBON AND A METHOD OF MAKING THE SAME

(71) Applicants: Douglas Robert Strachan, Lexington, KY (US); Joseph Kelly Stieha, Lexington, KY (US); David Patrick Hunley, Lexington, KY (US); Stephen Lee Johnson, JR., Lexington, KY (US)

(72) Inventors: Douglas Robert Strachan, Lexington, KY (US); Joseph Kelly Stieha, Lexington, KY (US); David Patrick Hunley, Lexington, KY (US); Stephen Lee Johnson, JR., Lexington, KY (US)

(73) Assignee: THE UNIVERSITY OF KENTUCKY RESEARCH FOUNDATION, Lexington, KY (US)

(21) Appl. No.: 13/538,308

(22) Filed: Jun. 29, 2012

(51) Int. Cl. C01B 31/04; B05D 3/10; B82Y 40/00; B82Y 30/00

(52) U.S. Cl. 428/220; 216/58; 216/63; 423/448; 977/842; 977/734

(57) ABSTRACT

A method of preparing graphene nanoribbons from a few-layer graphene film includes the steps of growing or placing a few-layer graphene film on a substrate, applying nanoparticles to a surface of the few-layer graphene layer on the substrate and performing chemical vapor etching. The resulting few-layer graphene nanoribbon has a thickness of between about 0.3 nm and about 50.0 nm and a width of between about 1.0 nm and about 20.0 nm.

### TECHNICAL FIELD

This document relates to nano-scale graphene materials and, more particularly, to graphene nanoribbons made from a few-layer graphene film.

### BACKGROUND SECTION

Graphene is a two-dimensional material having tremendous potential use in future nano-scale electronics while also providing a wealth of novel physical properties and phenomena. Graphene's extremely high carrier mobility, two-dimensionality, and unique band structure make it a potentially ideal material for a variety of ultra-fast electronics, chemical and biological sensors, and high-current carrying devices. In particular, the electrical properties of confined graphene structures are expected to strongly depend on the orientation and nature of the confining boundaries and edges. One of the exciting prospects is that the electrical properties of graphene might be engineered through the fine control over these confining boundaries. To achieve truly engineered graphene nano-electronics it is expected that the boundaries must be controlled to at least sub-10 nm precision—with a precision at the 1 nm scale likely necessary. However, mass producing these confining barriers to graphene at the 1 nm scale has remained elusive due to the resolution limits of standard nanolithography and other related processing techniques which are generally greater than 10 nm.

More specifically, there have recently been a number of efforts to confine graphene electronic structures on the sub-10 nm scale. The most utilized top-down technique to date has been the use of electron-beam lithography to construct a variety of structures such as Hall bars, nanoribbons, and quantum-dot three terminal transistors. Yet the precision of electron-beam lithography (EBL) does not permit reproducible fabrication or precision at the sub-10 nm scale. This means that EBL produces features which are rough on a scale typically larger than 10 nm, a size far larger than the precision required for graphene nanoribbon devices exhibiting high electron mobilities and spin valving effects. Other potential top-down techniques, such as electron-beam milling or ion-beam milling, do not provide significantly improved fabrication precision, nor (in the case electron-beam milling) the structural support required to construct the electrical components. A major limitation of current competing top-down processing methods (such as EBL, ion beam milling, and electron beam milling) is that they do not easily align themselves to crystal orientations of the graphene. This crystal orientation (often referred to as the chirality of the graphene edge) plays an important role in the electrical and thermal transport through graphene nanoribbons.

In addition to these top-down techniques, a number of bottom up approaches to forming graphene electronics with confining edges have been developed, such as tearing graphene nanoribbon strips and slicing open carbon nanotubes. However, these alternative methods utilize a random formation of the structures and do not present a significant improvement over current carbon nanotube device construction since they do not provide a means to form a plurality of nanoribbons all with the same chiral edges. Moreover, they do not provide a means to have these chirally pure nanoribbons oriented in the same direction on an insulating substrate (providing facile integration with electronics).

Although qualitative agreement exists between current top-down (lithographically) defined graphene structures and theoretical predictions, the true potential of fully engineered graphene electrical properties are far from realized. Though the graphene nanoribbons reported to-date show an increase in band gap (and as a result enhanced transistor on/off ratios), significantly increased band gaps are likely required for most electronic applications. Moreover, high current and thermoelectric applications will likely require parallel arrangements of nanoribbons in order to increase transport capacity and power generation.

The catalytic hydrogenation of graphite surfaces has been known for more than 40 years. This process comprises metallic catalyst particles that cause the graphite surface to react (at high furnace temperatures) with an atmosphere of H₂. These reactions have long been known to result in etch tracks formed in the graphite surface that often occur preferentially along specific crystal lattice orientations over the distance of microns or millimeters. We have recently demonstrated that this catalytic hydrogenation can also be achieved for few-layer graphene (FLG) films located on insulating SiO₂ substrates, and which has also been shown to occur on single-layer graphene as well. The significance of this discovery is that these etch tracks occur completely down to the insulating substrate, while still maintaining the crystallographic orientation of the few-layer (or single layer) graphene film. Thus, catalytic hydrogenation represents a method of cutting graphene so as to form crystallographically aligned insulating boundaries.

The present document describes for the first time how few-layer graphene (FLG), consisting of less than 10 layers, can be catalytically etched with metallic nanoparticles along highly crystallographic trenches or etch tracks to produce graphene nanoribbons with widths of less than 20 nm. These etch tracks are aligned due to apparent interactions within the graphene nanoparticle system during etching. The production of mass parallel nanoribbon structures can be enhanced and altered for applications by tuning various parameters including: (a) the chemical potential through electrostatic gating, (b) the size of the nanoparticles, (c) the number of layers of graphene, (d) the average inter-particle distance and (e) engineering strain with the graphene.

### SUMMARY SECTION

In accordance with the purposes described herein, a method of preparing FLG nanoribbons from a FLG film is provided. That method comprises growing a FLG film on a substrate, applying nanoparticles to a surface of the FLG film on the substrate and performing chemical vapor etching. The method includes (a) using a FLG film having a thickness of between about 0.3 nm and about 5.0 nm and (b) using nanoparticles having a diameter of between about 0.3 nm and about 50.0 nm.

In some embodiments the method includes (a) using a FLG film having a thickness of between about 0.3 nm and about 1.5 nm, (b) using nanoparticles having a size of between about 0.3 nm and about 10.0 nm and (c) positioning said nanoparticles on the FLG film at an inter-particle distance of between about 1.0 nm and about 1 micron.

In accordance with an additional aspect, this document relates to a FLG nanoribbon comprising a nanoribbon body of graphene having a thickness of between about 0.3 nm and about 50.0 nm and a width of between about 1.0 nm and about 20.0 nm. In one embodiment the nanoribbon has a zigzag atomic arrangement of carbon along an edge of the nanoribbon.

In accordance with yet another aspect a FLG nanoribbon product is provided. That product comprises a first nanoribbon having a first chirality and a second nanoribbon also having that same first chirality. Further the first and second nanoribbons are cut in parallel from a single graphene sheet, are crystallographically oriented along a common lattice orientation and include highly ordered edges.

### BRIEF DESCRIPTION OF THE DRAWING FIGURES

The accompanying drawing figures incorporated herein and forming a part of the specification, illustrate several aspects of the present embodiments and together with the description serve to explain certain principles of those embodiments. In the drawings:

FIG. 1a is an AFM image of graphene after catalytic etching showing several nanoribbons defined by etched trenches (the darker lines) and catalyst particles are illustrated as white dots;

FIG. 1b is a closer view of the nanoribbons within the dashed square in FIG. 1a;

FIG. 1c is a combined graphical representation showing the spatial correlation of the orientation and order at distances less than approximately 0.5 microns and showing long-range correlation for tracks to etch along the zigzag direction;

FIG. 1d is a graphical illustration of the zero correlation observed for non-interacting etching Monte Carlo simulation with the actual tracks shown in the inset;

FIG. 2a illustrates Monte Carlo simulation of catalytic etching in the presence of a 1/r potential interaction;

FIG. 2b illustrates the resulting orientation of correlation as a function of distance where distance is measured in units of the simulated sheet size (which is 200 nm for this specific simulation illustrated in FIG. 2a);

FIG. 3 is an SEM image of a FLG sample that has regions of parallel nanoribbons where the dark regions are FLG and the light regions are the underlying insulating substrate with the straight lines being tracks etched by the nanoparticles while the curvy lines are spurious nanotubes;

FIG. 4 is a detailed, close-up view of the parallel nanoribbons illustrated in FIG. 1;

FIGS. 5a and 5b are SEM images of FLG films with meander etch patterns with the white solid arrows guiding the eye to the last leg of meander path for each catalyst particle;

FIG. 5c is a schematical representation of proposed interdigitated nano-graphene electrodes that may be produced by the present method;

FIG. 6 is a schematical end elevational view illustrating a graphene nanoribbon prepared from a FLG film grown on a substrate; and

FIG. 7 is a schematical end elevational illustration of a FLG nanoribbon product comprising first and second nanoribbons having the same chirality and cut in parallel from a single FLG sheet grown on a substrate.

Reference will now be made in detail to the present preferred embodiments, examples of which are illustrated in the accompanying drawings.

### DETAILED DESCRIPTION

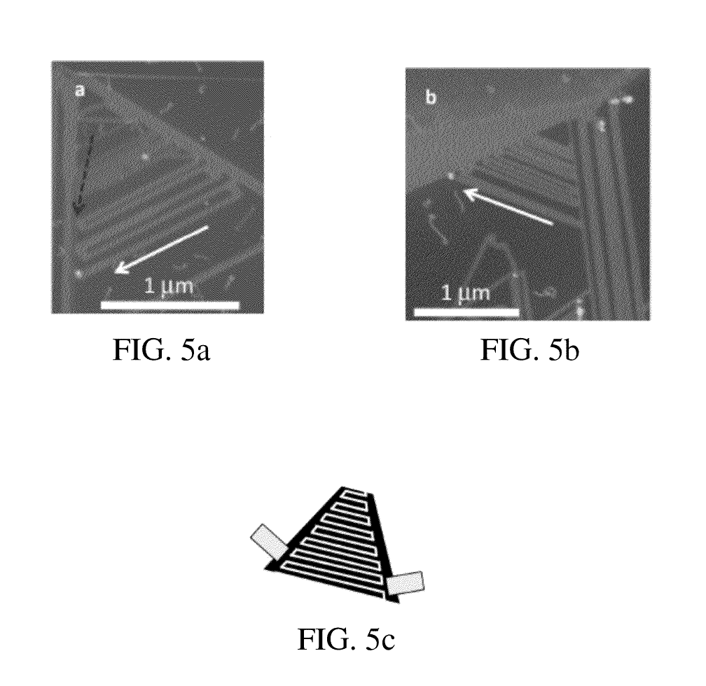

Reference is now made to FIG. 6 schematically illustrating a nanoribbon body of few-layer graphene prepared from a FLG film 12 on a substrate 14. The FLG nanoribbon 10 is etched from the FLG film 12 by applying nanoparticles 16 to the surface 18 of the FLG film on the substrate 14 and performing chemical vapor etching. As should be appreciated, the nanoparticles cut tracks 20 that define the boundary edges 22 of the nanoribbons 10.

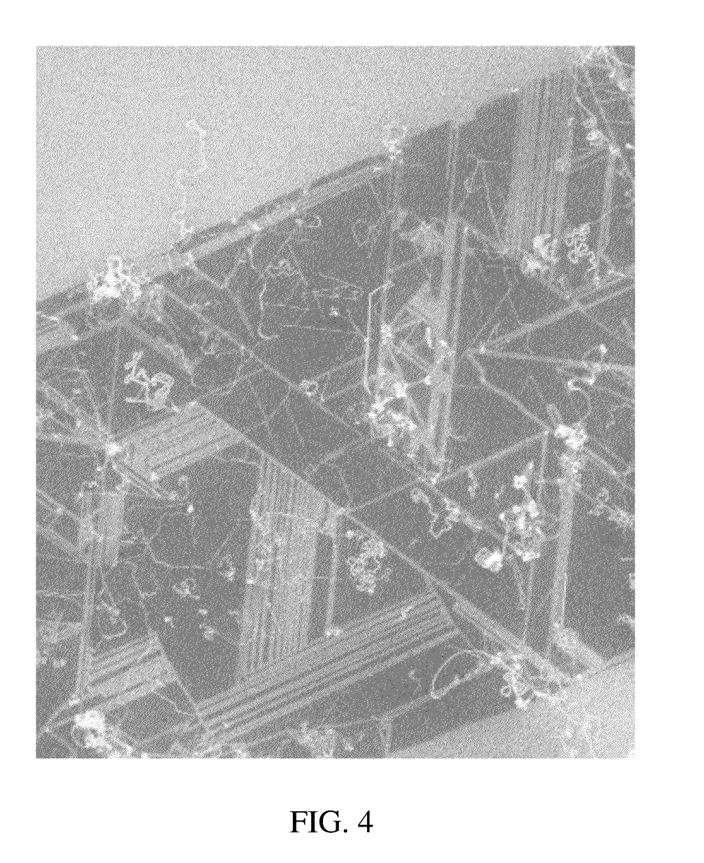

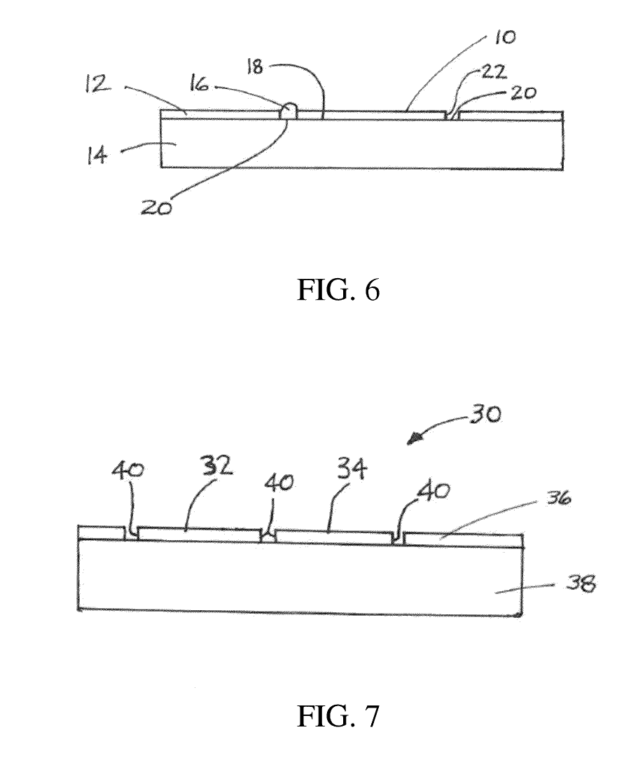

FIG. 7 illustrates a few-layer graphene nanoribbon product 30 comprising a first nanoribbon 32 and a second nanoribbon 34 both having a first or identical chirality. The first and second nanoribbons 32, 34 are cut in parallel from a single graphene sheet or film 36 grown on a substrate 38. Significantly, the nanoribbons 32, 34, cut in parallel from this single graphene sheet, are crystallographically oriented along a common lattice orientation and include highly ordered edges 40. Such as interdigitated FLG nanoribbon structure could be used as nanographene electrodes (see also FIG. 5).

The edges of the FLG nanoribbons 20, 32, 34 are typically highly ordered. In some embodiments the edges have a zigzag atomic arrangement of carbon. In some embodiments the carbon along the edges is terminated with hydrogen atoms. In some embodiments the carbon along the edges is terminated with an impurity element.

A method for preparing the graphene nanoribbons 10, 32, 34 may be broadly described as comprising growing a few-layer graphene film 12 on a substrate 14, applying nanoparticles 16 to a surface 18 on the few-layer graphene film on that substrate and performing chemical vapor etching. The method includes (a) using a few-layer graphene film 12 having a thickness of between about 0.3 nm and bout 5.0 nm and (b) using nanoparticles 16 having a diameter of between about 0.3 nm and about 50.0 nm. In one useful embodiment the method includes (a) using a few-layer graphene film 12 having a thickness of between about 0.3 nm and about 1.5 nm, (b) using nanoparticles 16 having a size of between about 0.3 nm and about 10.0 nm and (c) positioning those nanoparticles on the few-layer graphene film at an inter-particle distance of between about 1.0 nm and about 1 micron.

The method may further include applying a uniform voltage to the few-layer graphene film 12, while keeping the surrounding electrostatic environment electrically grounded, during chemical vapor etching. The applied uniform voltage may be of, for example, between about −1,000 to +1,000 volts. In one useful embodiment the method includes using a voltage of between −100 to +100 volts. The applied voltage functions to change the chemical potential of the graphene which in turn can influence the charge exchange between the catalyst particles and the FLG. By altering the charge exchange between catalyst particles and graphene, the effective interactions that the catalyst particle sees in the graphene environment will be altered. Thus, the interactions the catalyst particle has as it etches the graphene can be externally tuned by applying a voltage. The size of the voltage required to effectively tune the graphene depends on the strength of its capacitive coupling to a nearby ground (or zero voltage) electrode. Typical FLG samples having a ground plane approximately 300 nm away attain significant chemical potential control with voltage variation of between −100 to +100 volts. For FLG samples without such a ground plane, one would likely require a much larger voltage of about −1,000 to +1,000 volts. In all cases, the voltage is applied with high voltage amplifier with respect to the ground.

The method may further include inducing stress in the few-layer graphene film 12. This stress may be induced prior to chemical vapor etching or during chemical etching. In one possible embodiment the stress is induced by applying tension to the few-layer graphene film. Typically that tension may range from zero up to about 1 TPa. The induced stress functions to promote parallel and closely spaced etched tracks due to the changes in elastic energy as the catalyst particles induce bonds to be broken in the FLG sheet. The induced stress also functions to promote a preferred direction for the etch tracks—specifically the direction that relieves the most elastic energy induced in the FLG sheet.

In accordance with the present method the nanoparticles 16 utilized to cut the trenches form the nanoribbons 10, 32, 34 from the graphene film 12, 36 are composed from a metal selected from a group consisting of nickel, iron, cobalt, rhodium, ruthenium, platinum, palladium, gold and iridium metals, compounds of said metals, molecular complexes of said metals and mixtures thereof. The method includes using nanoparticles 16 having a size that is between about 100% and about 1,000% that of a thickness of the few-layer graphene film 12 from which the nanoribbons 10, 32, 34 are to be cut.

In some embodiments the chemical vapor etching step of the method includes completing an initial temperature ramp of at least 50° C. per minute up to a preforming temperature of between about 300° C. and about 500° C. and then etching the few-layer graphene film 12 with the nanoparticles 16 at an etching temperature of about 900° C. and about 1,000° C. In some embodiments the step of heating to a preforming temperature is skipped. Thus, the step of heating to a preforming temperature is optional.

More specifically, the method includes (a) maintaining the few-layer graphene film and the nanoparticles at the preforming temperature from between about 0 and about 120 minutes, (b) ramping directly up to the etching temperature or ramping up from the optional preforming temperature in less than about 30 minutes and (c) maintaining the few-layer graphene film and the nanoparticles at the etching temperature for up to about 200 minutes. In some embodiments the method includes supplying a gas flow mixture during chemical vapor etching including argon, hydrogen, and methane.

In accordance with another aspect, the method includes using an insulating substrate made from a material selected from a group consisting of SiO₂, Al₂O₃, Si₃N₄, BN, HfSiO₄, ZrSiO₄, HfO₂, and ZrO₂ and combinations thereof.

The following example is presented to illustrate the method and nanoribbons.

### Example

1. Graphene (SLG) or few-layer graphene (FLG) films are exfoliated, placed, or grown on an insulating or metallic substrate using well-established methods. The SLG films are ˜0.3 nm thick with FLG films of interest being N (integer) times this 0.3 nm thickness up to approximately 5 nm thick. We currently utilize exfoliated SLG and FLG samples (as described in detail below in section 1.a.), but there also exists several alternative methods (discussed in sections 1.b and 1.c). These alternative methods for SLG and FLG film fabrication, in addition to future improved methods for film fabrication on insulating or metallic substrates, could all be directly utilized for producing the invented parallel nanoribbons.
1a. Exfoliated samples use a “Scotch Tape” technique that is now standard in the field of graphene sample preparation. A piece of standard Scotch Tape is pressed against a small ˜1 cm sized slab of highly order pyrolytic graphite (HOPG). The graphite is thinned by repeated pressing and pealing of a second piece of Scotch Tape (adhesive sides facing each other). After sufficient thinning, the piece of tape is pressed against an insulating substrate. This method produces a variety of film thicknesses from single layer, to few-layer, and even thicker bulk graphite (>5 nm). The regions of SLG and FLG produced by exfoliation are typically greater than ˜5 microns square, which is significantly larger than the regions over which we currently observe parallel alignment of nanoribbons. Thus, the results and conclusions we obtain from exfoliated samples should pertain to other larger scale SLG and FLG fabrication methods (as in sections 1.b and 1.c).
1b. Placed samples can be formed through chemical vapor etching on a metallic catalyst sheet, such as Cu or Ni. The metallic sheet is removed with chemical reagents which leaves an FLG or SLG film that can be placed onto an insulating substrate.
1c. SiC surfaces can be heated to high temperatures, which removes the Si atoms on the surface leaving the C atoms to form a SLG or FLG film.

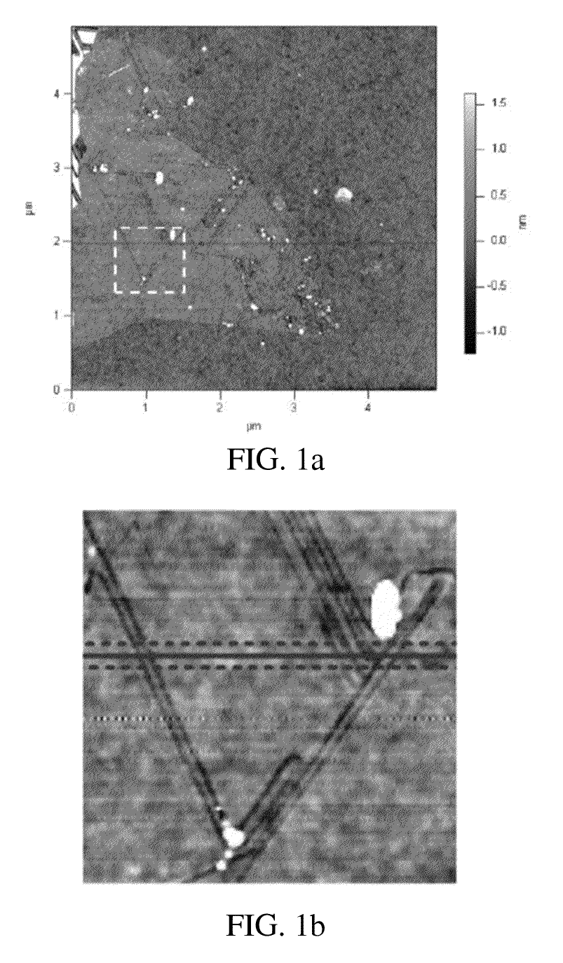

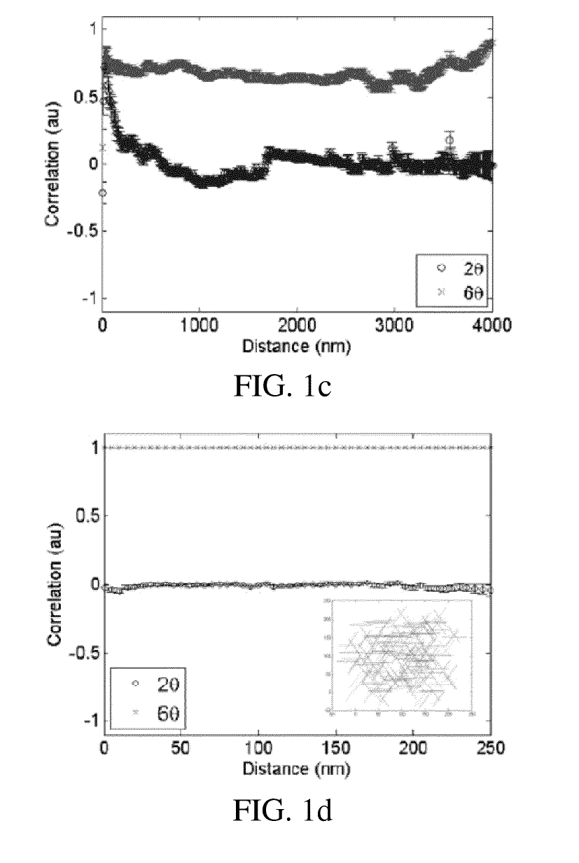

2. Metal is deposited onto the surface of the SLG or FLG through one of a number of possible methods. By using the various methods mentioned below, the size and density of the metallic nanoparticles can be adjusted. As discussed below (FIGS. 1 and 2), we find that etch tracks are correlated (ie, tend to align along the same direction) when tracks are within approximately 1 micron of each other. This alignment also seems to only occur for nanoparticles that are small enough such that their diameter is not more than approximately 10 times the thickness of the FLG film. As a result, the catalyst particle forming process requires small particles that are closely spaced. Fe or Ni containing salts (as discussed in section 2.a) and evaporating Ni (as discussed in section 2.b) were used to form the catalyst nanoparticles on top of the SLG and FLG films. So far we obtain the most significant parallel nanoribbon formation by utilizing the Ni containing salts, which may stem from their smaller size compared to the nanoparticles formed through the other methods.
2a. One method to form catalyst particles is done by placing a drop of solution of dissolved metal-containing salt. The salt is reduced in a furnace with a controlled atmosphere of H₂ and Ar resulting in metallic nanoparticles on the surface of the SLG or FLG.
2b. A second method uses an evaporator to deposit a thin metallic film approximately 1 nm thick or less on top of the SLG or FLG. This very thin layer of metal does not form a continuous film, but instead accumulates into small metallic nanoparticles on the SLG or FLG. The size of the nanoparticles can be controlled with evaporation conditions, such as temperature and evaporation rate.
2c. Another method is to spin coat (or “drop cast”) a solution of colloidal nanoparticles onto the surface of the graphene. Colloidal dispersions are available with metallic nanoparticles in a large range of sizes from ˜1 nm to more than a micron in size.
2d. Single molecule dispersions can also be applied to the surface of the SLG or FLG samples. If the molecules contain metal atoms, upon heating they can be reduced to ultra small metallic nanoparticles ˜1 nm or less on the surface of the SLG and FLG.
2e. Lithographic placing of metallic dots and islands onto the surface of the SLG or FLG which form the nanoparticles in specific locations. These can be formed with photo, imprint, inkjet, and electron beam lithographies.

3. Once the metallic nanoparticles are applied to the surface of the SLG or FLG, the sample is loaded into a chemical vapor etching (CVE) system and an Ar and H₂ gas flow mixture is applied to the system. The mixture contains approximately 850 sccm of Ar and 150 sccm of H₂ and is flown through a 1 inch diameter tube furnace. (Larger diameter furnaces can be used for larger scale fabrication by scaling up the overall flow rates with the cross-sectional area of the tube.) The gas flow is maintained while the sample environment is heated at a controlled rate.
3a. An initial temperature ramp of approximately 50° C./minute is performed to a preforming temperature (typically in the 300° C. to 500° C. temperature range) in order to completely form the nanoparticles and to give them enough energy so that they can migrate to the edges of the SLG and FLG samples. These preforming temperatures are low enough so that negligible etching of the SLG or FLG occurs.
3b. After the samples have been performed for roughly 30 minutes, the temperature is increased to a value where catalytic etching of the SLG or FLG sample can occur over a period of 10 to 60 minutes. This etching step is typically performed in the 900° C. to 1,000° C. range, where we observe the most significant nanoribbon alignment. The temperature ramp to the etching temperature should be performed as fast as possible in order to minimize reactions during the ramping stage. After etching, the sample is allowed to cool to room temperature under the maintained Ar—H₂ flow.

4. There are various external parameters that can be used to control the etching geometries of the samples. Our results indicate that nanoparticles with diameters which are roughly on the same size-scale as the FLG film thickness and not much more than about 10 times this thickness show the aligned etching that results in parallel nanoribbons. That is, in order to obtain parallel (or correlated) etching of a 5 nm thick FLG film requires roughly 5 to 50 nm diameter nanoparticles. Larger catalyst particles can be used to etch FLG and SLG but the etch tracks do not tend to form parallel nanoribbons.
4a. During the CVE processing described above, a voltage can be applied to the sample in order to adjust the interactions between nanoparticles, between nanoparticles and etch tracks, and between nanoparticles and SLG or FLG edges. Applying a voltage to the sample while grounding the back gate alters the chemical potential of the sample and can tune the electrostatic interactions within the SLG or FLG film. A typical voltage that can be applied to an SLG or FLG film on a 300 nm SiO2 substrate without experiencing electrical breakdown is ˜40 volts at the elevated temperatures used. This applied voltage results in negligible current in the graphene due to the high electrical resistance of the underlying SiO₂ layer.
4b. Varying the density, material, and size of the nanoparticles through the various methods discussed in detail in step 2 (above) will also influence the interactions within the SLG or FLG film and permit the tuning of the etching.
4c. Inducing stress within the SLG or FLG film can induce an effective interaction between nanoparticles, etch tracks, and edges. As nanoparticles etch they relieve the stresses within the film, a process that can effectively acts as a source of interactions within the film. Such internal stresses can be engineered by pulling the ends of SLG or FLG sheets. One way to achieve this on a local scale is by pulling the end of an SLG or FLG sheet with an atomic force microscope (AFM) tip. An alternative method for straining SLG and FLG on a much larger scale is to use a flexible substrate. As the substrate is bent or pulled, the SLG and FLG situated on top of it will be stressed. A third method of inducing stress is to suspend the FLG film over an etch pit. The geometrical shape of the boundaries of the etch pit, which can be engineered lithographically, will determine the stresses induced within the FLG. These stresses can be increased further by uniformly pulling the FLG sheet out of plane through electrostatic attraction with an underlying gate electrode.

FIGS. 1a and 1b show FLG etching with Ni catalyst particles that were spin coated from an aqueous salt solution. The resulting etch tracks show correlated etching. This correlation manifests itself through the alignment of nearby etch tracks. That is, the closer two etch tracks are to one another, the more likely that they will be located in the exact same crystallographic direction. Thus, the formation of nanoribbons, as seen in FIGS. 1a and 1b, is not accidental, but is in fact driven by interactions occurring in the graphene system during the catalytic hydrogenation processes. Quantifiable evidence for this correlation is found by appropriately mapping the system onto a spin-spin correlation analysis that avoids self-counting etch tracks. A typical correlation analysis for our etch tracks is shown in FIG. 1c (blue data), where it has a clearly non-zero value for distances less than ˜0.5 microns. To gain insight into this behavior we have compared these experimental results to Monte Carlo simulations of catalytic hydrogenation. The simulations without interactions result in a flat (ie, zero) correlation, as shown in FIG. 1d. In contrast, our simulations that incorporate an unscreened coulomb (˜1/r) repulsive interaction between the forming etch tracks show a non-zero orientational correlation as tracks approach each other (FIGS. 2a and 2b). These results suggest that long-range interactions help to drive the etching to form nanoribbons—a result which stands in contrast to a number of exclusively short-ranged models used to describe catalytic hydrogenation of graphite and graphene, which do not appear to be able to account for the significant correlation.

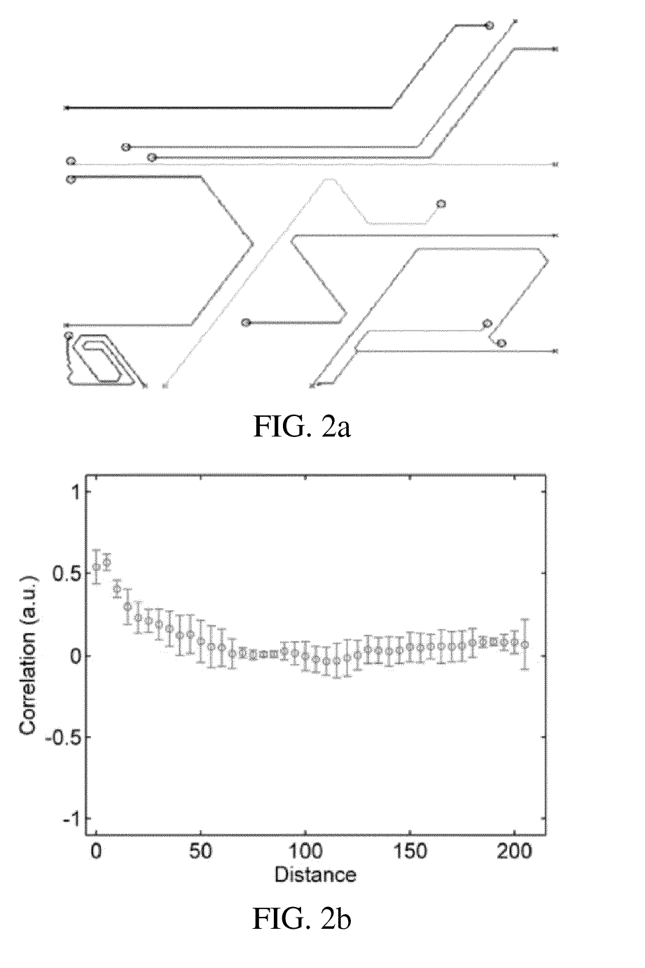

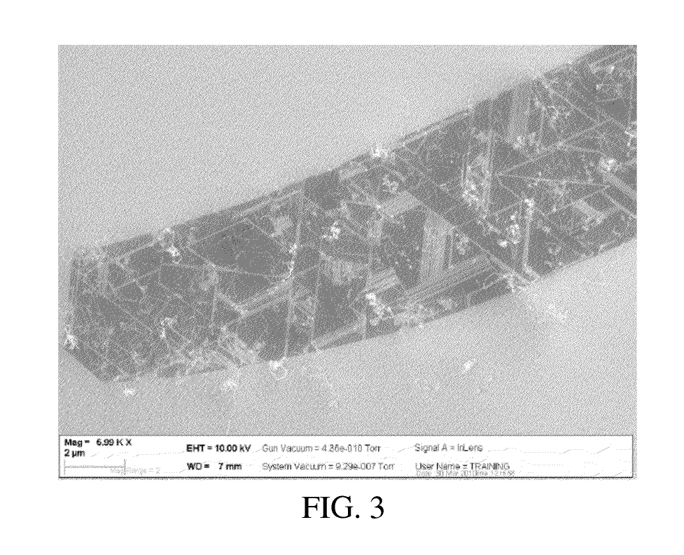

FIGS. 3 and 4 show a single FLG sample that has been catalytically etched into arrays of nanoribbons. The sample is prepared by placing a thin sub-nanometer layer of Ni onto the surface of a FLG sample and then heating it in a furnace to roughly 900° C. in a controlled atmosphere of Ar and H₂. As the temperature is increased the Ni coalesces into nanoparticles that etch the FLG at high temperatures. By changing the temperature ramp rate, the size of the nanoparticles can be controlled. Generally, a faster ramp yields smaller nanoparticles. We find that nanoparticles of specific sizes tend to yield arrays of parallel nanoribbons in FLG samples of a specific thickness (˜several nanometers). This is indicated in FIGS. 3 and 4 from the prevalence of nanoribbon arrays on a single graphene sheet. As the nanoparticles etch the surface of the FLG sample, they weave back and forth tracing out a series of parallel ribbons. Using the methods discussed above, the interactions promoting this back-and-forth nanoribbon formation can be enhanced and promoted to form large arrays.

There are many potential uses for the technology. Since highly conducting metallic conducting films less than 5 nm are not trivial to fabricate, nanoribbons formed from FLG less than this thickness could find a number of applications. Moreover, a number of quantum-size effects should occur within thin FLG and SLG that could be of use in constructing nano-scale transistors and sensors. Mass-parallel nanoribbons also have potential use in high-throughput nano-scale electronic applications, such as cross-bar memory and logic array systems, while the meander paths could find uses in nano-scale interdigitated electrodes for high-sensitivity thin-film biological and gas detection applications.

FIG. 5 shows one potential use for the SLG or FLG film meander etch pattern as a highly precise interdigitated electrode pair. FIGS. 5a and 5b show a meander etch pattern which could be used to develop an interdigitated electrode pair from the two sides of the FLG film separated by the etch track, as schematically represented in FIG. 5c. The unique aspects of this electrode pair is that it contains a highly uniform nano-scale trench with a width determined by a single metallic nanoparticle. Moreover, the electrode pair formed from SLG or FLG is extremely thin (˜1 nm or less) so that it will minimally disrupt the thin-film coating located on top of it.

Another novel application is towards thermoelectric generators. Recent theoretical work indicates that zigzag graphene nanoribbons could produce significant improvements to the thermoelectric figure of merit. The significant improvement in thermoelectric generation is expected to result from a reduced thermal conduction due to scattering from the edges of the nanoribbons accompanied with an electrical conduction which is only slightly reduced. The parallel zigzag nanoribbons we have discovered (FIGS. 3 and 4) are useful for increasing the magnitude of the electrical current produced (and likewise the power generated) for a fixed temperature difference since it will scale with the number of nanoribbons. Currently, other methods exist to produce single isolated nanoribbons of random chiral orientation. In contrast, our nanoribbons are all formed having the same spatial direction and chiral zigzag orientation. These parallel nanoribbons could have use in generating electricity in locations that naturally contain thermal gradients (ie, changes in temperature), such as layers of clothing when worn in very hot or cold environments.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled. For purpose of this document and the appended claims, few-layer graphene film includes films having between 1 and 17 layers.

What is claimed:

1. A method of preparing graphene nanoribbons from a few-layer graphene film, comprising:
growing a few-layer graphene film on a substrate;
applying nanoparticles to a surface on said few-layer graphene film on said substrate; and
performing chemical vapor etching.

2. The method of claim 1, including (a) using a few-layer graphene film having a thickness of between about 0.3 nm and about 5.0 nm and (b) using nanoparticles having a diameter of between about 0.3 nm and about 50.0 nm.

3. The method of claim 1, including (a) using a few-layer graphene film having a thickness of between about 0.3 nm and about 1.5 nm, (b) using nanoparticles having a size of between about 0.3 nm and about 15.0 nm and (c) positioning said nanoparticles on said few-layer graphene film at an inter-particle distance of between about 1.0 nm and about 1 micron.

4. The method of claim 1, further including applying a uniform voltage to said few-layer graphene film, while keeping the surrounding electrostatic environment electrically grounded, during chemical vapor etching.

5. The method of claim 4, including using a voltage of between about −1,000 to +1,000 volts.

6. The method of claim 4, including using a voltage of between about −100 to +100 volts.

7. The method of claim 1, further including inducing stress in said few-layer graphene film.

8. The method of claim 7, including inducing stress prior to chemical vapor etching.

9. The method of claim 7, including inducing stress during chemical vapor etching.

10. The method of claim 7, including inducing stress by applying tension to said few-layer graphene film.

11. The method of claim 1, including selecting nanoparticles composed from a metal selected from a group consisting of nickel, iron, cobalt, rhodium, ruthenium, platinum, palladium, gold, and iridium metals, compounds of said metals, molecular complexes of said metals and mixtures thereof.

12. The method of claim 1, including using nanoparticles having a size that is between about 100% and about 1000% that of a thickness of said few-layer graphene film.

13. The method of claim 1, wherein said chemical vapor etching includes completing an optional initial temperature ramp of at least 50° C./minute up to an optional preforming temperature of between about 300° C. and about 500° C. and etching said few-layer graphene film with said nanoparticles at an etching temperature of between about 900° C. and about 1,000° C.

14. The method of claim 13, including (a) maintaining said few-layer graphene film and said nanoparticles at said preforming temperature for between about 0 and about 120 minutes, (b) ramping up to said etching temperature from said performing temperature in less than about 30 minutes and (c) maintaining said few-layer graphene film and said nanoparticles at said etching temperature for up to about 200 minutes.

15. The method of claim 14, including supplying a gas flow mixture during chemical vapor etching including argon, hydrogen, and methane.

16. The method of claim 1, including using an insulating substrate made from a material selected from a group consisting of SiO₂, Al₂O₃, Si₃N₄, BN, HfSiO₄, ZrSiO₄, HfO₂, and ZrO₂ and combinations thereof.

17. A few-layer graphene nanoribbon, comprising:
a nanoribbon body of graphene having a thickness of between about 0.3 nm and about 50.0 nm and a width of between about 1.0 nm and about 20.0 nm.

18. The nanoribbon of claim 17, having a zigzag atomic arrangement of carbon along an edge of said nanoribbon body.

19. The nanoribbon of claim 18, having a zigzag atomic arrangement of carbon along the edge which is terminated with hydrogen atoms.

20. The nanoribbon of claim 17 wherein said nanoribbon has a width of less than 10 nm.

21. A few-layer graphene nanoribbon product, comprising:
a first nanoribbon having a first chirality;
a second nanoribbon also having said first chirality;
where said first and second nanoribbons are cut in parallel from a single graphene sheet, are crystallographically oriented along a common lattice orientation and include highly ordered edges.
